(19) United States
(12) Patent Application Publication
(10) Pub. No.: US 2003/0209930 A1
(43) Pub. Date: Nov. 13, 2003

(54) Seat track assembly with locking mechanism

(76) Inventors: Keith C. Horsfield, Bracebridge (CA); Hugh D. Downey, Barrie (CA)

Correspondence Address: BANNER & WITCOFF, LTD., 28 STATE STREET, 28th FLOOR, BOSTON, MA, 02109-9601, US

(21) Appl. No.: 10/400,178

(22) Filed: Mar. 26, 2003

Related U.S. Application Data
(63) Continuation of application No. 09/901,491, filed on Jul. 9, 2001, now abandoned.

(51) Int. Cl. F16M 13/00

(52) U.S. Cl. 297/344.1

(57) ABSTRACT

A seat track assembly includes a first seat track having a plurality of apertures and a second seat track supported for movement relative to the first seat track. At least one pin is movable from an engaged position with an aperture to a disengaged position. A handle is pivotally connected to the second seat track. A connecting member is pivotally connected to the second seat track and to the handle, and engages the plurality of pins such that the connecting member can move each pin from its engaged position to its disengaged position upon movement of the handle.

### FIELD OF THE INVENTION

This invention relates generally to the field of seat mounting assemblies, and in particular, to seat track assemblies having a mechanism to move a seat between a locked and unlocked position.

### BACKGROUND OF THE INVENTION

Vehicle seats are often provided with a seat track assembly for adjusting the horizontal fore and aft seat position. Such seat track assemblies generally include upper seat tracks on each side of the seat movably mounted to corresponding lower seat tracks fixed to the vehicle. The upper seat tracks are typically affixed to the underside of the vehicle seat, directly to a base of the seat or to a seat pan. For the front seats of a motor vehicle, two seat track assemblies are employed, one along each side of the seat base. The seat pan, and seat risers, if employed, allow the seat to be positioned at an angle and a height deemed most suitable for an occupant of a motor vehicle.

In order to provide positive engagement of the seat with the vehicle, a locking assembly typically has a plurality of pins that engage in locking fashion with apertures, or windows, formed in the first seat track. A handle or towel bar is used by an occupant of the vehicle to engage and disengage the pins, thereby allowing for horizontal adjustment of the seat. When an operator pulls up on the towel bar, the pins are disengaged from the first seat track, permitting adjustment of the horizontal position of the seat.

U.S. Pat. No. 6,231,022 to Becker et al. shows a device for connecting a towel bar to a plurality of pins that engage apertures in a seat track. Becker is limiting in that the mechanism connecting the towel bar to the pins is of complex construction, leading to increased costs, reduced performance, and difficulty in manufacturing such parts.

It is an object of the present invention to provide seat track assemblies that reduce or wholly overcome some or all of the difficulties inherent in prior known devices. Particular objects and advantages of the invention will be apparent to those skilled in the art, that is, those who are knowledgeable or experienced in this field of technology, in view of the following disclosure of the invention and detailed description of preferred embodiments.

### BRIEF SUMMARY OF THE INVENTION

The principles of the invention may be used to advantage to provide a seat track assembly that provides a simple and effective interface between a handle, such as a towel bar, and the linear action of at least one locking pin of a locking mechanism. Its design provides for smooth, quiet and easy operation of the handle, with enhanced performance of the locking mechanism.

In accordance with a first embodiment, a seat track assembly for mounting a seat in a vehicle includes a first seat track having a plurality of apertures. A second seat track is supported for movement relative to the first seat track. At least one pin is included, with each pin movable from an engaged position with an aperture to a disengaged position. A handle is pivotally connected to the second seat track. A connecting member is pivotally connected to the second seat track and to the handle, and engages the plurality of pins such that the each pin moves from its engaged position to its disengaged position upon movement of the handle.

In accordance with a second embodiment, a seat track assembly for mounting a seat in a vehicle includes a seat bottom and a seat back pivotally supported for movement relative to the seat bottom. A first seat track has a plurality of apertures. A second seat track is supported for movement relative to the first seat track, and the seat bottom is secured to the second seat track. A plurality of pins are included, with each pin movable from an engaged position with an aperture to a disengaged position. A plurality of springs are also included, each spring biasing a corresponding pin into its engaged position. A handle is pivotally connected to the second seat track. A connecting member is pivotally connected to the second seat track and to the handle, and engages the plurality of pins such that the each pin moves from its engaged position to its disengaged position upon movement of the handle.

In accordance with yet another embodiment, a seat track assembly for mounting a seat in a vehicle includes a first seat track having a plurality of apertures. A second seat track is supported for movement relative to the first seat track. A pivot pin is secured to the second seat track, and a plurality of housings are secured to the second seat track. A plurality of pins are included, with each pin slidably received in a corresponding housing and movable from an engaged position with an aperture to a disengaged position. A plurality of springs are also included, with each spring biasing a corresponding pin into its engaged position. A towel bar is pivotally connected to the second seat track. A connecting member has a pair of arms at a first end thereof to receive the towel bar, a plurality of arms at a second end thereof and a plurality of flanges, each flange supporting a pin. At least two arms of the plurality of arms have apertures to receive the pivot bar and pivotally connect the connecting member to the second seat track. The connecting member moves the plurality of pins from engaged positions in corresponding apertures to disengaged positions upon movement of the towel bar.

From the foregoing disclosure, it will be readily apparent to those skilled in the art, that is, those who are knowledgeable or experienced in this area of technology, that the present invention provides a significant advance. Preferred embodiments of the seat track assembly of the present invention can provide an efficient and cost-effective manner of interfacing a handle with a locking mechanism including at least one pin.

These and additional features and advantages of the invention disclosed here will be further understood from the following detailed disclosure of preferred embodiments.

### BRIEF DESCRIPTION OF THE DRAWINGS

FIG. 1 is an elevation view of a seat assembly mounted on a pair of seat tracks in accordance with the present invention.

FIG. 2 is a perspective view of a mounting assembly for the seat assembly of FIG. 1, including a pair of seat track assemblies.

FIG. 3 is a perspective view of a first seat track of a seat track assembly of FIG. 2.

FIG. 4 is a schematic elevation view of the locking pins of a locking assembly of FIG. 2, shown in operation with the first seat track of FIG. 3.

FIG. 5 is a plan view of a seat track assembly of FIG. 2, shown with a locking pin in an engaged position with an aperture.

FIG. 6 is a plan view of a seat track assembly of FIG. 2, shown with a locking pin being moved out of an engaged position with an aperture.

FIG. 7 is a plan view of a seat track assembly of FIG. 2, shown with a locking pin in a disengaged position.

FIG. 8 is a perspective view of a connecting member of a seat track assembly of FIG. 2.

### DETAILED DESCRIPTION OF THE INVENTION

Although specific embodiments of the present disclosure will now be described with reference to the drawings, it should be understood that such embodiments are by way of example only and merely illustrative of but a small number of the many possible specific embodiments which can represent applications of the principles of the present disclosure.

Various changes and modifications will be obvious to one skilled in the art in view of the present disclosure and are deemed to be within the spirit and scope of the present disclosure as further defined in the appended claims. Unless defined otherwise, all technical and scientific terms used herein have the same meaning as commonly understood by one having ordinary skill in the art to which this disclosure belongs.

Although other materials and methods similar or equivalent to those described here can be used in the practice or testing of the present disclosure, certain preferred methods and materials are now described.

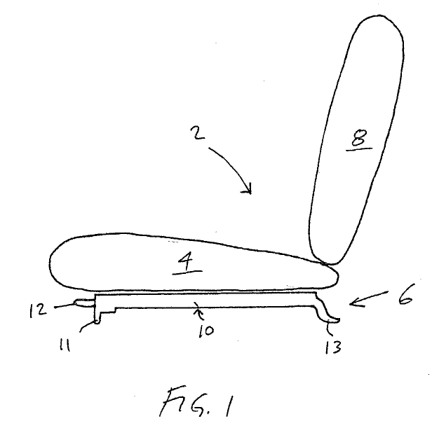

FIG. 1 illustrates a vehicle seat assembly 2 in accordance with a preferred embodiment of the present invention. Seat assembly 2 includes a seat bottom 4 that is mounted within the vehicle on a mounting assembly 6. A seat back 8 is supported for movement relative to seat bottom 4. Seat back 8 is preferably pivotally mounted with respect to seat bottom 4 so that seat back 8 can be folded forwardly and rearward with respect to seat bottom 4.

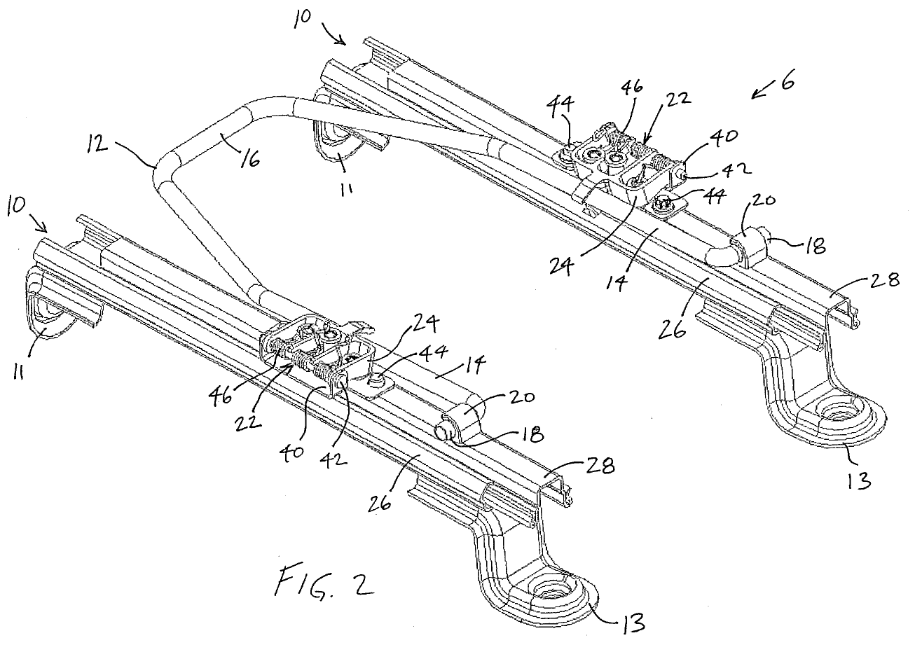

As seen in FIG. 2, mounting assembly 6 includes a pair of track assemblies 10, mounted on opposite sides of seat assembly 2. Track assemblies 10 are secured to a vehicle via a front bracket 11 and a rear bracket 13 that are secured to the vehicle via bolts (not shown). A handle or towel bar 12, accessible by a seat occupant, is operably connected to both track assemblies 10. Towel bar 12 is a generally C-shaped member with two leg portions 14 interconnected by a central portion 16. End portions 18 of leg portions 14 are turned outwardly and are pivotally secured to track assemblies 10 by brackets 20. In a preferred embodiment, a locking assembly 22 is provided on each track assembly 10.

However, it is to be appreciated that a locking assembly 22 could be positioned on only one track assembly 10. A leg portion 14 is connected to each locking assembly 22 via a connecting member or link 24. Central portion 16 is adjacent to the front of the seat bottom 4 and serves as the handle that is actuated by a seat occupant. When central portion 16 is lifted upwardly toward the seat bottom 4, leg portions 14 move connecting links 24 upwardly, releasing locking assemblies 22 from a locked position to an unlocked position, as described in greater detail below, allowing the seat assembly 2 to be adjusted forwardly or rearwardly.

Each track assembly 10 includes a first track 26 and a second track 28. Preferably, the first track 26 is a lower track 26 that is fixedly mounted to a frame of the vehicle, via front bracket 11 and rear bracket 13 for example. The second track 28 is preferably an upper track 28 that is received over the lower track 26 so that the upper track 28 can be moved in a forward or rearward direction relative to the lower track 26. The terms forward, rearward, upper, and lower, as used in this description, are for illustration purposes only and are not intended to be limiting. The profiles of the lower track 26 and the upper track 28 ensure that the upper track 28 only moves along a longitudinal axis of the tracks and does not move in other directions.

As seen in FIG. 3, lower track 26 includes a plurality of windows or apertures 39 along its length, with apertures 39 separated by webs 41. In a preferred embodiment, apertures 39 are formed of semicircular end portions 43 joined together by straight edges 45, forming a generally racetrack shaped aperture. At each end of lower track 26, a pair of mounting apertures 29 is provided for attachment of lower track 26 to front bracket 11 and rear bracket 13 via bolts (not shown).

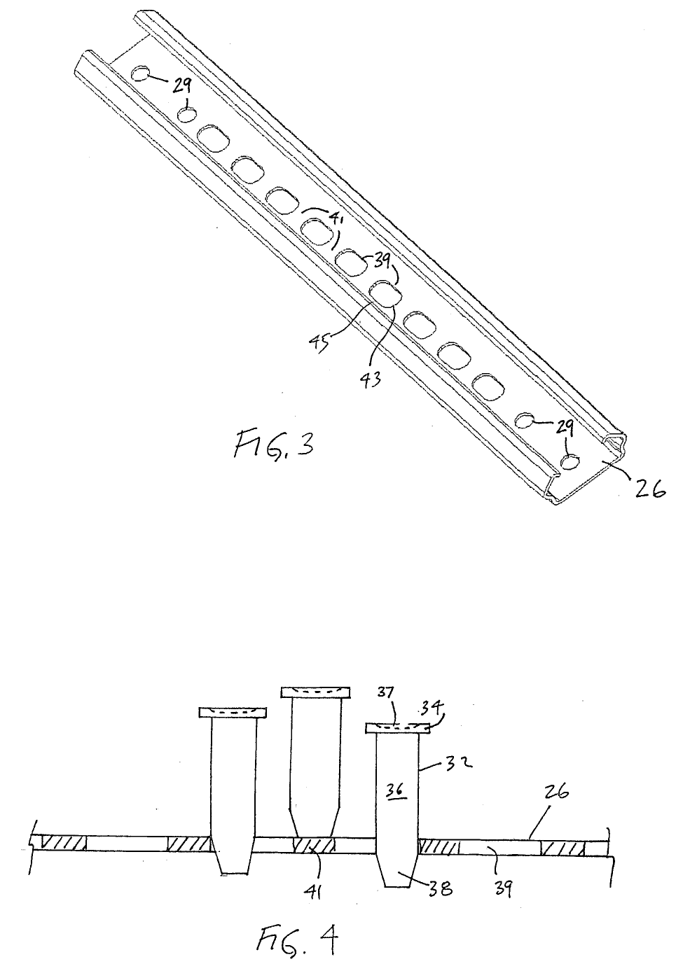

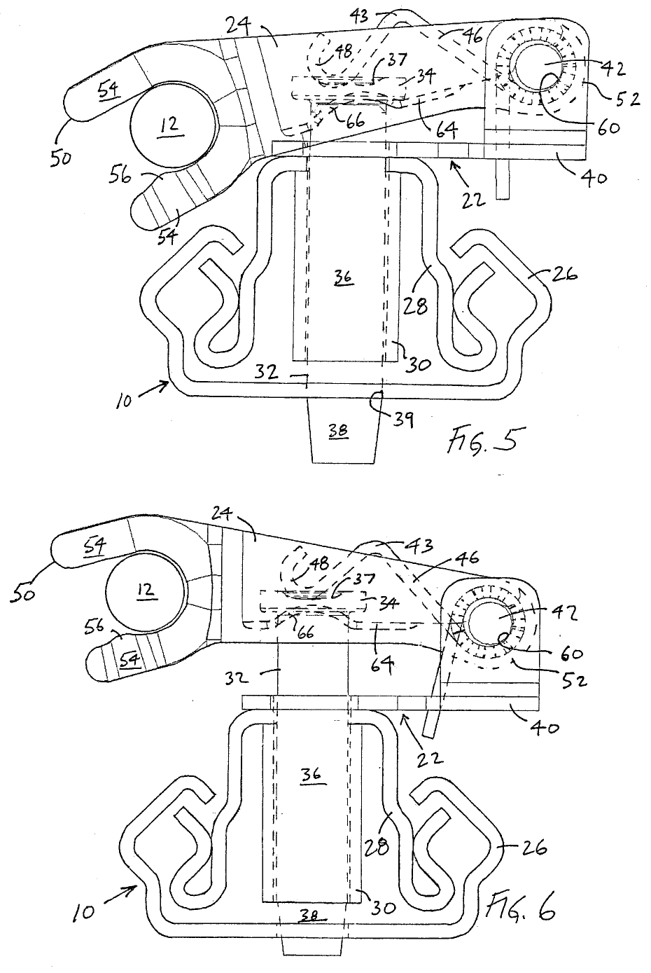

Locking assembly 22, described in greater detail below with respect to FIGS. 5-7, includes at least one locking pin 32. In the illustrated embodiment, there are three pins 32 that provide for positive engagement with apertures 39, thereby retaining seat assembly 2 in a locked position. It is to be appreciated that the present invention is not limited to embodiments with three pins, and that a locking assembly with greater or fewer pins is considered to be within the scope of the present invention. As seen in FIG. 4, locking pins 32 have a head 34, a body 36 and a tapered end 38. A recess 37 is preferably formed in the top surface of head 34. Pins 32 are movable into and out of engagement with corresponding apertures 39 formed in lower seat track 26. In the embodiment with three pins 32, the length of apertures 39 is approximately twice the length of web 41 (i.e., the distance between adjacent apertures). The web length is approximately the same as the diameter of pins 32, and the width of apertures 39 is slightly larger than the diameter of pins 32. In one preferred embodiment, apertures 39 are 20 mm long and 12 mm wide, web 41 is 10 mm long, and the diameter of pins 32 is 10 mm.

As noted above, when seat assembly 2 is to be moved, locking assembly 22 is released by raising towel bar 12 such that pins 32 are free of engagement with apertures 39. After seat assembly 2 is moved to a desired position, towel bar 12 is lowered and pins 32 descend, forced downwardly by a biasing spring, described below. As a first pin 32 (the rightmost pin as seen in FIG. 4) encounters an aperture 39 it is forced downwardly into an aperture 39. At this point, there is still forward and rearward play in seat assembly 2, since the length of aperture 39 is twice the diameter of pin 32 and the pin is free to move until it reaches an end of the aperture. When the first pin reaches the end of the aperture 39 in which it is positioned as the seat moves, seen here as the right end of the aperture in which the rightmost pin 32 is positioned, a second pin 32 (the leftmost pin as seen in FIG. 4) first encounters an adjacent aperture 39 and is forced downwardly therein. The third pin 32 (the center pin as seen in FIG. 4) rests on a web 41 located between the two adjacent apertures 39 in which the first and second pins 32 are positioned. Due to the geometry of the pins and lower seat track, that is, the size of the pins, the length of the apertures, the width of the webs, and the spacing of the pins, in this embodiment the second pin engages the left end of its aperture 39, while at the same time, the first pin engages the right end of its aperture 39. Thus, movement of seat assembly 2 is prevented in either direction along the path of travel of upper seat track 28 by engagement of these two pins 32 within the adjacent apertures 39. Such a configuration is known as a “chuckless” system, since chucking refers to movement of the seat tracks with respect to one another after engagement of a locking assembly. In a three pin embodiment, such as the embodiment illustrated here, only two pins are engaged in apertures when the seat assembly is locked in position, with the third pin resting on a web. In another example, not shown here, two adjacent pins could engage apertures on either side of a web, with the third pin (the leftmost or rightmost pin) resting on a web.

As noted above, other numbers of pins can be used in accordance with the principles of the present invention. In the case where two pins are used, for example, the length of the apertures is two times the length of the web, such that the pins can each be engaged in opposed ends of the same aperture, or engage adjacent apertures on either side of a web. The geometry required for other numbers of pins will be readily apparent to those skilled in the art, and further discussion need not be provided here.

Locking assembly 22 is shown in greater detail in FIGS. 5-7. Locking assembly 22 includes a plurality of housings 30 secured to upper seat track 28. A locking pin 32 is slidably received in each housing 30, and is free to move within housing 30. A bracket 40, supporting a pivot pin 42, is secured to an upper surface of second seat track 28 via a fastener 44, such as a rivet or bolt as seen in FIG. 2. Leaf springs 46 are wrapped around pivot pin 42, and a generally J-shaped end portion 48 of each leaf spring 46 seats in recess 37 of head 34 of a pin 32, biasing pin 32 toward engagement with a corresponding aperture 39. By forming end portion 48 to be generally J-shaped, and seating it in recess 37, an improved bearing surface for leaf spring 46 on pin 32 is provided. A 90° bend 43 is provided in a central portion of leaf spring 46 to ensure that J-shaped portion 48 seats in recess 37 at all times during the travel of connecting link 24.

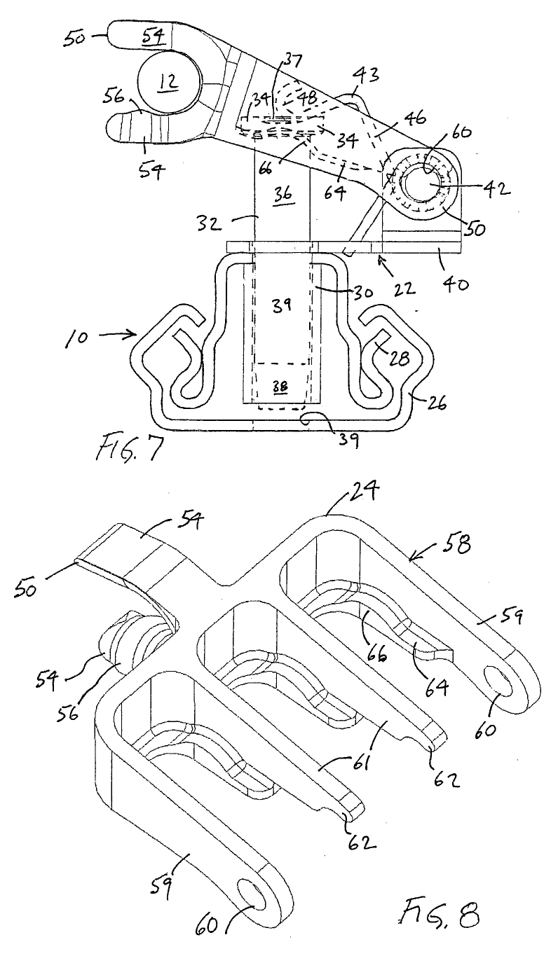

FIG. 5 shows a pin 32 fully engaged within an aperture 39, with towel bar 12 in its rest position and seat assembly 2 locked in place. FIG. 6 illustrates towel bar 12 being raised, and, more particularly, with connecting link 24 being at a midpoint of its travel. In a preferred embodiment, connecting link 24 has approximately 30° of travel, with approximately 15° being both above and below a horizontal position. Pins 32 are seen here being lifted out of, or lowered into engagement with apertures 39. FIG. 7 shows towel bar 12 in its fully raised position, with pins 32 being totally free of apertures 39, and seat assembly 2 free to move forwardly or rearwardly.

A first end 50 of connecting link 24 is pivotally connected to towel bar 12, and a second end 52 is pivotally connected to second seat track 28 via pivot pin 42. It is to be appreciated that other methods of pivotally securing connecting link 24 to upper seat track 28 are considered to be within the scope of the invention. For example, connecting link 24 may, in certain preferred embodiments, be directly connected in rotatable or pivotal fashion to upper seat track 28 itself, without the need for a separate pivot pin. As seen more clearly in FIG. 6, first end 50 is preferably a generally U-shaped member, formed of a pair of arms 54, that receives towel bar 12, allowing connecting link 24 to pivot about towel bar 12. Second end 52 includes a plurality of arms 58. Each of the outermost pair of arms 59 has an aperture 60 that receives pivot pin 42, such that connecting link 24 can pivot about upper seat track 28. The remaining, or inner arms 61 have a curved finger 62 that rests on and is supported by pivot pin 42 as connecting link 24 rotates about pivot pin 42.

In a preferred embodiment, an interference fit between towel bar 12 and first end 50 is provided, preferably by making the distance between arms 54 slightly smaller than the diameter of towel bar 12. In certain preferred embodiments, one arm 54 (the lower arm in the illustrated embodiment) includes a raised portion or projection 56, preventing towel bar 12 from sliding out from between arms 54 when seat assembly 2 is in its locked position and towel bar is in its rest position. In certain preferred embodiments, U-shaped first end 50 is angled downward slightly such that when towel bar is in its raised position and pins 32 are disengaged from apertures 39, towel bar cannot slip out from between arms 54. In the illustrated embodiment, where the connecting member travels approximately 30°, first end 50 is angled downwardly approximately 30° such that the upper arm 54 of first end 50 is substantially horizontal when towel bar 12 is in its fully raised position where pins 32 are totally disengaged from apertures 39.

A flange 64 is positioned between each arm 58 of a pair of adjacent arms 58. Thus, in the illustrated embodiment, where there are three pins 32, there are four arms 58, and, correspondingly, three flanges 64. Flanges 64 form a generally U-shaped supporting surface for heads 34 of pins 32. As towel bar 12 is raised, flanges 64 engage heads 34 and force pins 32 upwardly out of engagement with apertures 39. In a preferred embodiment, raised portions or projections 66 are formed on each side of flanges 64. As can be seen in FIGS. 5-7, as connecting link 24 rotates, projections 66 engage heads 34 throughout the travel of connecting link 24, providing point contact between heads 34 and flanges 64, thereby minimizing the chance for binding of heads 34 with connecting link 24. In certain preferred embodiments, as seen in FIG. 6, flanges 64 are approximately horizontal with respect to the path of travel of upper seat track 28 when connecting link 24 is at a midpoint of its travel.

Connecting link 24 provides a simple and effective interface between towel bar 12 and the linear action of pins 32. Its design provides for smooth, quiet and easy operation of towel bar 12, with enhanced performance of locking assembly 22, particularly pins 32. The present invention easily converts the vertical translation of towel bar 12, through the angular displacement of connecting link 24, to the vertical translation of pins 32.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

We claim:

1. A seat track assembly for mounting a seat in a vehicle comprising, in combination:
a first seat track having a plurality of apertures;
a second seat track supported for movement relative to the first seat track;
at least one pin, each pin movable from an engaged position with an aperture to a disengaged position;
a handle pivotally connected to the second seat track; and
a connecting member pivotally connected to the second seat track and to the handle, and engaging the plurality of pins such that each pin moves from its engaged position to its disengaged position upon movement of the handle.

2. The seat track assembly of claim 1, wherein a first end of the connecting member includes a pair of arms configured to receive the handle.

3. The seat track assembly of claim 2, wherein the handle is a bar and the pair of arms connect to the handle with an interference fit.

4. The seat track assembly of claim 2, wherein one arm of the pair of arms has a raised portion thereon to maintain the handle within the pair of arms.

5. The seat track assembly of claim 2, wherein the arms extend at an angle such that an upper arm of the pair of arms is substantially horizontal when the handle is in a fully raised position.

6. The seat track assembly of claim 1, wherein each pin is supported by a flange formed on the connecting member.

7. The seat track assembly of claim 6, wherein each flange extends substantially horizontally with respect to a path of travel of the second track at a midpoint of a path of travel of the connecting member.

8. The seat track assembly of claim 6, wherein each flange is substantially U-shaped.

9. The seat track assembly of claim 8, wherein each flange has a raised portion formed on each of opposite arms of the U-shaped flange.

10. The seat track assembly of claim 1, wherein a second end of the connecting member includes a plurality of arms.

11. The seat track assembly of claim 10, wherein the second seat track includes a pivot bar, and at least one arm of the plurality of arms has an aperture formed therein to receive the pivot bar.

12. The seat track assembly of claim 10, wherein the second seat track includes a pivot bar, and an outermost pair of arms of the plurality of arms each have an aperture formed therein to receive the pivot bar.

13. The seat track assembly of claim 10, wherein at least one arm of the plurality of arms has a finger formed at an end thereof, configured to abut and rest on the pivot bar as the connecting member pivots about the pivot bar.

14. The seat track assembly of claim 10, wherein flanges are formed between adjacent aims of the plurality of arms, each flange supporting a pin.

15. The seat track assembly of claim 1, further comprising a plurality of housings secured to the second seat track, wherein each pin is slidably received in a corresponding housing.

16. The seat track assembly of claim 1, wherein the at least one pin comprises three pins.

17. The seat track assembly of claim 16, wherein the first track includes a web positioned between each of adjacent apertures, two pins being engaged in an aperture and one pin resting on a web when the second seat track is in a locked position with respect to the first seat track.

18. The seat track assembly of claim 1, further comprising at least one biasing member, each biasing member biasing a corresponding pin toward engagement with an aperture.

19. A seat track assembly for mounting a seat in a vehicle comprising, in combination:
a seat bottom;
a seat back pivotally supported for movement relative to the seat bottom;
a first seat track having a plurality of apertures;
a second seat track supported for movement relative to the first seat track, the seat bottom being secured to the second seat track;
a plurality of pins, each pin movable from an engaged position with an aperture to a disengaged position;
a plurality of springs, each spring biasing a corresponding pin into its engaged position;
a handle pivotally connected to the second seat track; and
a connecting member pivotally connected to the second seat track and to the handle, and engaging the plurality of pins such that each pin moves from its engaged position to its disengaged position upon movement of the handle.

20. A seat track assembly for mounting a seat in a vehicle comprising, in combination:
a first seat track having a plurality of apertures;
a second seat track supported for movement relative to the first seat track;
a pivot pin secured to the second seat track;
a plurality of housings secured to the second seat track;
a plurality of pins, each pin slidably received in a corresponding housing and movable from an engaged position with an aperture to a disengaged position;
a plurality of springs, each spring biasing a corresponding pin into its engaged position;
a towel bar pivotally connected to the second seat track; and
a connecting member having a pair of arms at a first end thereof to receive the towel bar, a plurality of arms at a second end thereof, at least two arms of the plurality of arms having apertures to receive the pivot bar and pivotally connect the connecting member to the second seat track, and a plurality of flanges, each flange supporting a pin, wherein the connecting member moves the plurality of pins from engaged positions in corresponding apertures to disengaged positions upon movement of the towel bar.
